(19) United States
(12) Patent Application Publication
(10) Pub. No.: US 2024/0137969 A1
(43) Pub. Date: Apr. 25, 2024

(54) DISCONTINUOUS TRANSMISSION (DTX) INFORMATION TRANSMISSION METHOD AND APPARATUS THEREOF

(71) Applicant: MEDIATEK INC., Hsinchu City (TW)

(72) Inventors: Ming LEE, Hsinchu City (TW); Ying-Han TANG, Hsinchu City (TW); Sih-Ci LIN, Hsinchu City (TW)

(21) Appl. No.: 18/488,429

(22) Filed: Oct. 16, 2023

Related U.S. Application Data
(60) Provisional application No. 63/418,042, filed on Oct. 21, 2022.

(51) Int. Cl. H04W 72/542; H04W 52/02; H04W 76/28

(52) U.S. Cl. CPC H04W 72/542; H04W 52/0203; H04W 76/28

(57) ABSTRACT

A discontinuous transmission (DTX) information transmission method is provided. The DTX information transmission method may include the following steps. A processor of an apparatus may determine whether to enter a DTX mode. A transceiver of the apparatus may transmit DTX information to a network node in response to determining to enter the DTX mode.

### CROSS REFERENCE TO RELATED APPLICATIONS

This application claims the benefits of U.S. Provisional Application No. 63/418,042 filed on Oct. 21, 2022, the entirety of which is incorporated by reference herein.

### BACKGROUND OF THE INVENTION

### Field of the Invention

The invention generally relates to wireless communication technology, and more particularly, to a discontinuous transmission (DTX) information transmission technology in which the UE can transmit the DTX information to the network node.

### Description of the Related Art

GSM/GPRS/EDGE technology is also called 2G cellular technology, WCDMA/CDMA-2000/TD-SCDMA technology is also called 3G cellular technology, and LTE/LTE-A/TD-LTE technology is also called 4G cellular technology. These cellular technologies have been adopted for use in various telecommunication standards to provide a common protocol that enables different wireless devices to communicate on a municipal, national, regional, and even global level. An example of an emerging telecommunication standard is 5G New Radio (NR), which is a set of enhancements to the LTE mobile standard promulgated by the Third Generation Partnership Project (3GPP). It is designed to better support mobile broadband Internet access by improving spectral efficiency, reducing costs, and improving services.

However, when the UE enters specific radio conditions (i.e., when the connection status of the UE is changed or the signal quality of the UE becomes worse), the network node may perceive the UE to be DTX-like, and the network node cannot immediately know that what circumstances the UE being encountered. The network node may still allocate or provide network resources to the UE. Therefore, the network resource and the power of the network node may be wasted. In an example, for downlink (DL) communication, the network node may repeatedly send a downlink transport block for a Hybrid Automatic Repeat Request (HARQ) process via a physical downlink shared channel (PDSCH) because the network node cannot receive HARQ feedback from the UE. In another example, for uplink (UL) communication, the network node may assign uplink grants for PUSCH retransmission multiple times for a HARQ process. In addition, for a UE that supports dual-Subscriber Identity Module (SIM) dual active, if the UE cannot support dual-SIM simultaneous transmission, the network resources may be wasted.

Therefore, how to efficiently allocate network resources when the UE enters the specific radio conditions is a topic that is worthy of discussion.

### BRIEF SUMMARY OF THE INVENTION

A discontinuous transmission (DTX) information transmission method and an apparatus are provided to overcome the problems mentioned above.

An embodiment of the invention provides a discontinuous transmission (DTX) information transmission method. The DTX information transmission method may include the following steps. A processor of an apparatus may determine whether to enter a DTX mode. A transceiver of the apparatus may transmit DTX information to a network node in response to determining to enter the DTX mode.

In some embodiments, the apparatus supports a dual Subscriber Identity Module (SIM) function. The DTX information transmission method may further include the following steps. The processor may perform a first service corresponding to a first SIM. The processor may determine that a second service corresponding to a second SIM will be performed, wherein the second service is more critical than the first service. The transceiver may transmit the DTX information corresponding to the first SIM to the network node to indicate that the first SIM will enter the DTX mode. In addition, the processor may perform the second service corresponding to the second SIM in response to the first SIM entering the DTX mode, and the transceiver may transmit the DTX information corresponding to the second SIM to the network node to indicate that the second SIM will enter the DTX mode in an event that the second service will be terminated. In addition, the transceiver may transmit a scheduling request to the network node for the first service in an event that the second SIM will enter the DTX mode, and the processor may perform the first service again in response to the second SIM entering the DTX mode.

In some embodiments, the DTX information transmission method may further include the following steps. The processor may determine whether the apparatus will enter an environment with at least one poor radio condition. The processor may determine to enter the DTX mode in an event that the apparatus will enter the environment with at least one poor radio condition. Then, the transceiver may transmit the DTX information to the network node in response to determining to enter the DTX mode. In addition, the transceiver may transmit a scheduling request to the network node to acquire a resource for a service, in response to leaving the DTX mode. In addition, the poor radio condition may comprise that reception is bad in the environment or a signal is weak in the environment.

In some embodiments, the transceiver may transmit the DTX information to the network node through medium resource control (MAC) layer signaling or physical layer signaling.

An embodiment of the invention provides apparatus for discontinuous transmission (DTX) information transmission. The apparatus may comprise a transceiver and a processor. The processor is coupled to the transceiver. The processor may be configured to determine whether to enter a DTX mode, and transmit, via the transceiver, DTX information to a network node in response to determining to enter the DTX mode.

An embodiment of the invention provides a discontinuous transmission (DTX) information transmission method. The DTX information transmission method may include the following steps. A transceiver of a network node may receive DTX information from a user equipment (UE), wherein the DTX information indicates that the UE will enter a DTX mode. A processor of the network node may determine a resource allocation based on the DTX information.

Other aspects and features of the invention will become apparent to those with ordinary skill in the art upon review of the following descriptions of specific embodiments of the DTX information transmission methods and an apparatus.

### BRIEF DESCRIPTION OF THE DRAWINGS

The invention will become more fully understood by referring to the following detailed description with reference to the accompanying drawings, wherein:

FIG. 1 is a block diagram of a wireless communications system 100 according to an embodiment of the invention.

FIG. 2 is a block diagram of a communication apparatus 200 according to an embodiment of the invention.

FIG. 3 is a block diagram of a network apparatus 300 according to an embodiment of the invention.

FIG. 4 is a schematic diagram illustrating DTX information transmission according to an embodiment of the invention.

FIG. 5 is a schematic diagram illustrating DTX information transmission according to another embodiment of the invention.

FIG. 6 is a flow chart illustrating a DTX information transmission method according to an embodiment of the invention.

FIG. 7 is a flow chart illustrating a DTX information transmission method according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

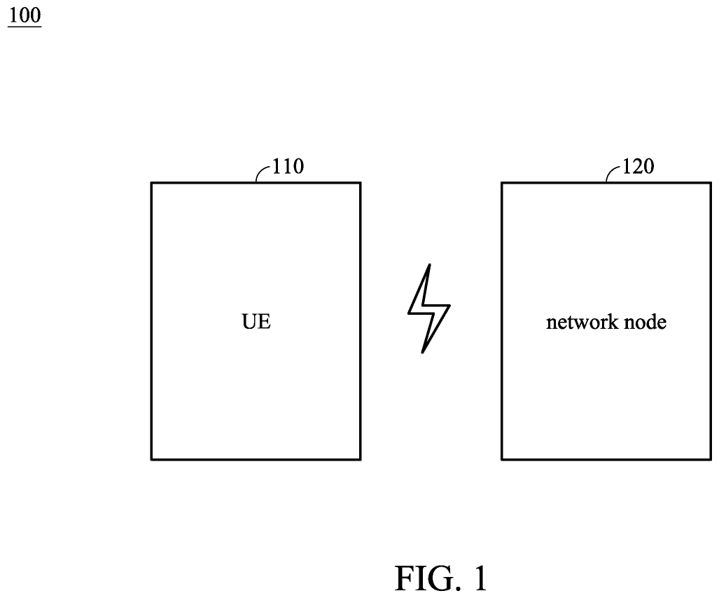

FIG. 1 is a block diagram of a wireless communications system 100 according to an embodiment of the invention. As shown in FIG. 1, the wireless communications system 100 may comprise user equipment (UE) 110 and a network node 120. It should be noted that in order to clarify the concept of the invention, FIG. 1 presents a simplified block diagram in which only the elements relevant to the invention are shown. However, the invention should not be limited to what is shown in FIG. 1.

In the embodiments of the invention, the UE 110 may be a smartphone, Personal Data Assistant (PDA), pager, laptop computer, desktop computer, wireless handset, or any computing device that includes a wireless communications interface.

In the embodiments, the network node 120 may be a base station, a gNodeB (gNB), a NodeB (NB) an eNodeB (eNB), an access point, an access terminal, but the invention should not be limited thereto. In the embodiments, the UE 110 may communicate with the network node 120 through the fourth generation (4G) communication technology, fifth generation (5G) communication technology (or 5G New Radio (NR) communication technology), or sixth generation (6G) communication technology, but the invention should not be limited thereto.

According to an embodiment of the invention, the UE 110 may wirelessly communicate with both the service network nodes (e.g., network node 120 and another network node) using two separate subscriber identities (or referred to as subscriber numbers). The subscriber identities may be provided by two subscriber identity cards (e.g., Subscriber Identity Module (SIM) cards or Universal SIM (USIM) cards) (not shown) in compliance with the specifications of the RAT utilized by different service network nodes.

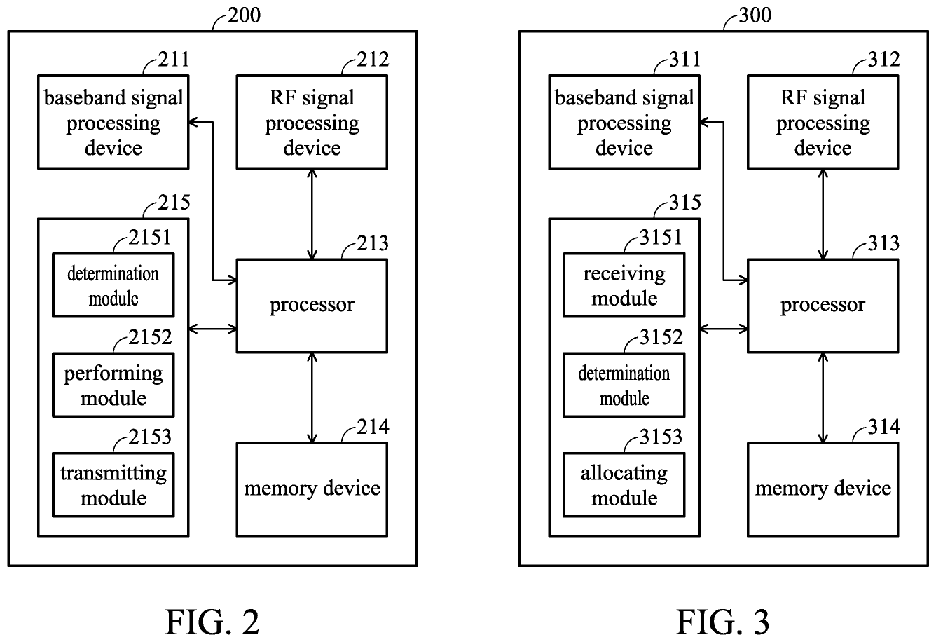

FIG. 2 is a block diagram of a communication apparatus 200 according to an embodiment of the invention. The communication apparatus 200 may be applied to UE 110. As shown in FIG. 2, the communication apparatus 200 may comprise at least a baseband signal processing device 211, a radio frequency (RF) signal processing device 212, a processor 213, a memory device 214, and function modules and circuits 215.

The RF signal processing device 212 may be a transceiver. The RF signal processing device 212 may comprise a plurality of antennas to receive or transmit RF signals. The RF signal processing device 212 may receive RF signals via the antennas and process the received RF signals to convert the received RF signals to baseband signals to be processed by the baseband signal processing device 211, or receive baseband signals from the baseband signal processing device 211 and convert the received baseband signals to RF signals to be transmitted to a peer communications apparatus. The RF signal processing device 212 may comprise a plurality of hardware elements to perform radio frequency conversion. For example, the RF signal processing device 212 may comprise a power amplifier, a mixer, analog-to-digital converter (ADC)/digital-to-analog converter (DAC), etc.

The baseband signal processing device 211 may further process the baseband signals to obtain information or data transmitted by the peer communications apparatus. The baseband signal processing device 211 may also comprise a plurality of hardware elements to perform baseband signal processing.

The processor 213 may control the operations of the baseband signal processing device 211, the RF signal processing device 212, the memory device 214 and the function modules and circuits 215. According to an embodiment of the invention, the processor 213 may also be arranged to execute the program codes of the software module(s) of the corresponding baseband signal processing device 211, the RF signal processing device 212 and the function modules and circuits 215. The program codes accompanied by specific data in a data structure may also be referred to as a processor logic unit or a stack instance when being executed. Therefore, the processor 213 may be regarded as being comprised of a plurality of processor logic units, each for executing one or more specific functions or tasks of the corresponding software modules.

The memory device 214 may store the software and firmware program codes, system data, user data, etc. of the communication apparatus 200. The memory device 214 may be a volatile memory such as a Random Access Memory (RAM); a non-volatile memory such as a flash memory or Read-Only Memory (ROM); a hard disk; or any combination thereof.

According to an embodiment of the invention, the RF signal processing device 212 and the baseband signal processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2.

The function modules and circuits 215 may comprise a determination module 2151, a performing module 2152 and a transmitting module 2153. The processor 213 may execute different modules or circuits in the function modules and circuits 215 to perform embodiments of the present invention. In the embodiment of the invention, the determination module 2151 may determine whether to enter a discontinuous transmission (DTX) mode. The performing module 2152 may perform services from the network node. The transmitting module 2153 may transmit the DTX information to the network node.

According to an embodiment of the invention, the communication apparatus 200 may perform wireless transmission and reception to and from the cells formed by the two different service network nodes using two subscriber identity cards. That is, two subscriber identity cards may be allocated in the communication apparatus 200 respectively for the different services from different network nodes.

FIG. 3 is a block diagram of a network apparatus 300 according to an embodiment of the invention. The network apparatus 300 may be applied to the network node 120. As shown in FIG. 3, the network apparatus 300 may comprise at least a baseband signal processing device 311, a RF signal processing device 312, a processor 313, a memory device 314, and function modules and circuits 315.

The RF signal processing device 312 may be a transceiver. The RF signal processing device 312 may comprise a plurality of antennas to receive or transmit RF signals. The RF signal processing device 312 may receive RF signals via the antennas and process the received RF signals to convert the received RF signals to baseband signals to be processed by the baseband signal processing device 311, or receive baseband signals from the baseband signal processing device 311 and convert the received baseband signals to RF signals to be transmitted to a peer communications apparatus. The RF signal processing device 312 may comprise a plurality of hardware elements to perform radio frequency conversion. For example, the RF signal processing device 312 may comprise a power amplifier, a mixer, ADC/DAC, etc.

The baseband signal processing device 311 may further process the baseband signals to obtain information or data transmitted by the peer communications apparatus. The baseband signal processing device 311 may also comprise a plurality of hardware elements to perform baseband signal processing.

The processor 313 may control the operations of the baseband signal processing device 311, the RF signal processing device 312, the memory device 314 and the function modules and circuits 315. According to an embodiment of the invention, the processor 313 may also be arranged to execute the program codes of the software module(s) of the corresponding baseband signal processing device 311, the RF signal processing device 312 and the function modules and circuits 315. The program codes accompanied by specific data in a data structure may also be referred to as a processor logic unit or a stack instance when being executed. Therefore, the processor 313 may be regarded as being comprised of a plurality of processor logic units, each for executing one or more specific functions or tasks of the corresponding software modules.

The memory device 314 may store the software and firmware program codes, system data, user data, etc. of the network node apparatus 300. The memory device 314 may be a volatile memory such as a RAM; a non-volatile memory such as a flash memory or ROM; a hard disk; or any combination thereof.

According to an embodiment of the invention, the RF signal processing device 312 and the baseband signal processing device 311 may collectively be regarded as a radio module capable of communicating with a wireless network to provide wireless communications services in compliance with a predetermined Radio Access Technology (RAT). Note that, in some embodiments of the invention, the network apparatus 300 may be extended further to comprise more than one antenna and/or more than one radio module, and the invention should not be limited to what is shown in FIG. 3.

The function modules and circuits 315 may comprise a receiving module 3151, a determination module 3152 and an allocating module 3153. The processor 313 may execute different modules or circuits in the function modules and circuits 315 to perform embodiments of the present invention. In the embodiment of the invention, the receiving module 3151 may receive DTX information from the UE. The determination module 3152 may determine the resource allocation for the UE. The allocating module 3153 may allocate the resource to the UE.

According to the embodiments of the invention, the UE 110 may determine whether to enter a DTX mode (i.e., when the connection status of the UE is changed or the signal quality of the UE becomes worse, the UE may perform DTX). When the UE 110 determines to enter the DTX mode, the UE 110 may transmit the DTX information to the network node 120 to indicate that the UE 110 will enter the DTX mode. Then, the network node 120 may determine the resource allocation for the UE 110 based on the DTX information from the UE 110.

According to an embodiment of the invention, the UE 110 may transmit the DTX information to the network node 120 through medium access control (MAC) layer signaling (e.g., MAC control element (MAC-CE), logical channel identity (LCID), uplink-shared channel (UL-SCH), buffer status reporting (BUF), but the invention should not be limited thereto), or a physical layer signaling (e.g., physical uplink control channel (PUCCH), sounding reference sign (SRS), but the invention should not be limited thereto).

According to an embodiment of the invention, when the UE 110 supports a dual Subscriber Identity Module (SIM) function, when a first SIM (indicated as SIM 1 below) of the UE 110 is in the connected mode, the UE 110 may perform a first service (e.g., internet data upload) corresponding to the SIM 1. For example, the UE 110 may upload the data for the first service. In addition, the UE 110 may determine whether a second service corresponding to a second SIM (indicated as SIM 2 below) will be performed. When the UE 110 determines that a second service corresponding to the SIM 2 will be performed and the second service is more critical than the first service, e.g., the second service may be a live streaming download, the UE 110 may determine that the SIM 1 may need to enter the DTX mode temporarily. Then, the UE 110 may transmit the DTX information corresponding to the SIM 1 to the network node corresponding to the SIM 1 to indicate that the SIM 1 will enter the DTX mode. When the network node corresponding to the SIM 1 receives the DTX information, the network node corresponding to the SIM 1 may stop allocating or providing resources for the first service based on the DTX information.

When the SIM 1 enters the DTX mode, the UE 110 may perform the second service corresponding to the SIM 2. In addition, the UE 110 may determine whether the SIM 2 needing to enter the DTX mode. For example, when the download live stream data for the second service has achieved an enough amount, the UE 110 may determine that the SIM 2 needs to enter the DTX mode. When the SIM 2 will enter the DTX mode, the UE 110 may transmit the DTX information corresponding to the SIM 2 to the network node corresponding to the SIM 2 to indicate that the SIM 2 will enter the DTX mode (i.e., the second service will be terminated). When the network node corresponding to the SIM 2 receives the DTX information, the network node corresponding to the SIM 2 may stop allocating or providing resources for the second service based on the DTX information.

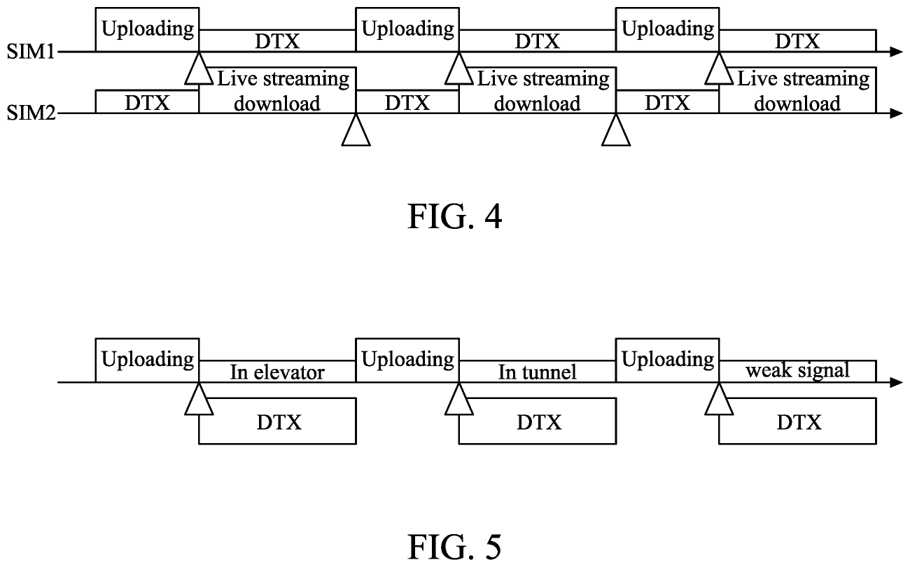

In addition, when the SIM 2 will enter the DTX mode, the UE 110 may transmit a scheduling request to the network node corresponding to the SIM 1 to ask the resources for the first service. When the network node corresponding to the SIM 1 receives the scheduling request, the network node corresponding to the SIM 1 may allocate resources to the UE 110 for the first service. Then, the UE 110 may perform the first service again when the second SIM enters the DTX mode. FIG. 4 is taken as an example for illustrating the example.

FIG. 4 is a schematic diagram illustrating DTX information transmission according to an embodiment of the invention. As shown in FIG. 4, the UE 110 may support a dual SIM function. Before the SIM 1 or the SIM 2 enters the DTX mode, the UE 110 may transmit the DTX information to the network node. The triangle sign may be used to indicate a timing of transmitting the DTX information to the network node.

According to an embodiment of the invention, the UE 110 may determine whether the UE 110 will enter an environment with at least one poor radio condition. In an embodiment, the poor radio condition may comprise that reception of UE 110 is bad in the environment (e.g., the UE 110 will enter an elevator or a tunnel, but the invention should not be limited thereto) or a signal is weak in the environment (e.g., the signal quality or signal strength is lower than a threshold, but the invention should not be limited thereto).

When the UE 110 determines that the UE 110 will enter an environment with at least one poor radio condition, the UE 110 may determine to enter the DTX mode. In addition, the UE 110 may transmit the DTX information to the network node to indicate that the UE 110 will enter the DTX mode. When the network node receives the DTX information, the network node may stop allocating or providing resources to the UE 110 based on the DTX information.

In addition, when the UE leaves the DTX mode, the UE 110 may transmit a scheduling request to the network node to acquire a resource from the network node for its service. When the network node receives the scheduling request, the network node may allocate the resources to the UE 110 based on the scheduling request. FIG. 5 is taken as an example for illustrating the example.

FIG. 5 is a schematic diagram illustrating DTX information transmission according to another embodiment of the invention. As shown in FIG. 5, when the UE 110 determines that the UE 110 will enter an environment with at least one poor radio condition, the UE 110 may determine to enter the DTX mode. Then, the UE 110 may transmit the DTX information to the network node. The triangle sign may be used to indicate a timing of transmitting the DTX information to the network node. In addition, when the UE leaves the DTX mode, the UE 110 may transmit a scheduling request to the network to acquire a resource from the network node.

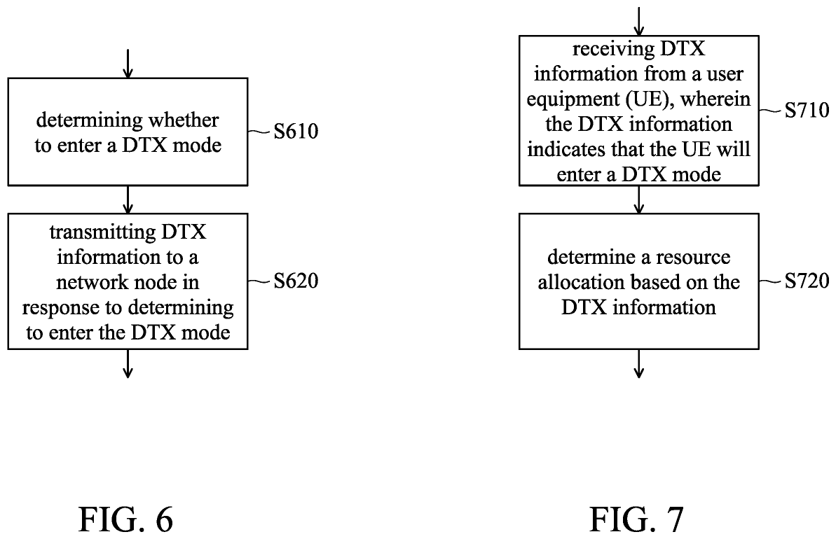

FIG. 6 is a flow chart illustrating a discontinuous transmission (DTX) information transmission method according to an embodiment of the invention. The DTX information transmission method can be applied to the wireless communication network 100. As shown in FIG. 6, in step S610, the UE 110 of the wireless communication network 100 may determine whether to enter a DTX mode.

In step S620, the UE 110 may transmit DTX information to a network node in response to determining to enter the DTX mode.

In some embodiments, in the DTX information transmission method, the UE 110 may support a dual Subscriber Identity Module (SIM) function. The UE 110 may perform a first service corresponding to a first SIM. The UE 110 may determine that a second service corresponding to a second SIM will be performed, wherein the second service is more critical than the first service. Then, the UE 110 may transmit the DTX information corresponding to the first SIM to the network node to indicate that the first SIM will enter the DTX mode.

In some embodiments, in the DTX information transmission method, the UE 110 may perform the second service corresponding to the second SIM in response to the first SIM entering the DTX mode. In addition, the UE 110 may transmit the DTX information corresponding to the second SIM to the network node to indicate that the second SIM will enter the DTX mode in an event that the second service will be terminated.

In some embodiments, in the DTX information transmission method, the UE 110 may transmit a scheduling request to the network node for the first service in an event that the second SIM will enter the DTX mode. In addition, the UE 110 may perform the first service again in response to the second SIM entering the DTX mode.

In some embodiments, in the DTX information transmission method, the UE 110 may determine whether the apparatus will enter an environment with at least one poor radio condition. The UE 110 may determine to enter the DTX mode in an event that the apparatus will enter the environment with at least one poor radio condition. In addition, the UE 110 may transmit the DTX information to the network node in response to determining to enter the DTX mode.

In some embodiments, in the DTX information transmission method, the UE 110 may transmit a scheduling request to the network node to acquire a resource for a service, in response to leaving the DTX mode.

In some embodiments, in the DTX information transmission method, the poor radio condition comprises that reception is bad in the environment or a signal is weak in the environment.

In some embodiments, in the DTX information transmission method, the UE 110 may transmit the DTX information to the network node through medium access control (MAC) layer signaling or physical layer signaling.

FIG. 7 is a flow chart illustrating a discontinuous transmission (DTX) information transmission method according to another embodiment of the invention. The DTX information transmission method can be applied to the wireless communication network 100. As shown in FIG. 7, in step S710, the network node 120 may receive DTX information from a user equipment (UE), wherein the DTX information indicates that the UE will enter a DTX mode.

In step S720, the network node 120 may determine a resource allocation based on the DTX information.

In some embodiments, in the DTX information transmission method, the UE may support a dual Subscriber Identity Module (SIM) function. The network node 120 may receive the DTX information corresponding to a first SIM of the UE from the UE to know that the first SIM will enter the DTX mode. In addition, the network node 120 may stop providing resource for a first service on the first SIM.

In some embodiments, in the DTX information transmission method, the network node 120 may allocate resource for a second service on a second SIM of the UE. The network node 120 may receive the DTX information corresponding to the second SIM from the UE to know that the second SIM will enter the DTX mode. The network node 120 may receive a scheduling request from the UE for the first service. In addition, the network node 120 may allocate the resources for the first service on the first SIM again.

In some embodiments, in the DTX information transmission method, the network node 120 may receive the DTX information in an event that the UE will enter an environment with at least one poor radio condition.

In the DTX information transmission methods provided in the invention, the UE can provide the DTX information to the network node. Therefore, the network node will be able to adjust the resource allocation based on the DTX information immediately. Therefore, the resource allocation of the network node can be more efficient, and the better energy efficiency for the network node can be achieved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A discontinuous transmission (DTX) information transmission method, comprising:
determining, by a processor of an apparatus, whether to enter a DTX mode; and
transmitting, by a transceiver of the apparatus, DTX information to a network node in response to determining to enter the DTX mode.

2. The DTX information transmission method of claim 1, wherein the apparatus supports a dual Subscriber Identity Module (SIM) function, and the method further comprises:
performing, by the processor, a first service corresponding to a first SIM;
determining, by the processor, that a second service corresponding to a second SIM will be performed, wherein the second service is more critical than the first service; and
transmitting, by the transceiver, the DTX information corresponding to the first SIM to the network node to indicate that the first SIM will enter the DTX mode.

3. The DTX information transmission method of claim 2, further comprising:
performing, by the processor, the second service corresponding to the second SIM in response to the first SIM entering the DTX mode; and
transmitting, by the transceiver, the DTX information corresponding to the second SIM to the network node to indicate that the second SIM will enter the DTX mode in an event that the second service will be terminated.

4. The DTX information transmission method of claim 3, further comprising:
transmitting, by the transceiver, a scheduling request to the network node for the first service in an event that the second SIM will enter the DTX mode; and
performing, by the processor, the first service again in response to the second SIM entering the DTX mode.

5. The DTX information transmission method of claim 1, further comprising:
determining, by the processor, whether the apparatus will enter an environment with at least one poor radio condition;
determining, by the processor, to enter the DTX mode in an event that the apparatus will enter the environment with the at least one poor radio condition; and
transmitting, by the transceiver, the DTX information to the network node in response to determining to enter the DTX mode.

6. The DTX information transmission method of claim 5, further comprising:
transmitting, by the transceiver, a scheduling request to the network node to acquire a resource for a service, in response to leaving the DTX mode.

7. The DTX information transmission method of claim 5, wherein the at least one poor radio condition comprises that a reception is bad in the environment or a signal is weak in the environment.

8. The DTX information transmission method of claim 1, further comprising:
transmitting, by the transceiver, the DTX information to the network node through medium access control (MAC) layer signaling or physical layer signaling.

9. An apparatus for discontinuous transmission (DTX) information transmission, comprising:
a transceiver; and
a processor, coupled to the transceiver, and configured to:
determine whether to enter a DTX mode; and
transmit, via the transceiver, DTX information to a network node in response to determining to enter the DTX mode.

10. The apparatus of claim 9, wherein the apparatus supports a dual Subscriber Identity Module (SIM) function, and the processor is further configured to:
perform a first service corresponding to a first SIM;
determine that a second service corresponding to a second SIM will be performed, wherein the second service is more critical than the first service; and
transmit, via the transceiver, the DTX information corresponding to the first SIM to the network node to indicate that the first SIM will enter the DTX mode.

11. The apparatus of claim 10, wherein the processor is further configured to:
perform the second service corresponding to the second SIM in response to the first SIM entering the DTX mode; and
transmit, via the transceiver, the DTX information corresponding to the second SIM to the network node to indicate that the second SIM will enter the DTX mode in an event that the second service will be terminated.

12. The apparatus of claim 11, wherein the processor is further configured to:
transmit, via the transceiver, a scheduling request to the network node for the first service in an event that the second SIM will enter the DTX mode; and
perform the first service again in response to the second SIM entering the DTX mode.

13. The apparatus of claim 9, wherein the processor is further configured to:
determine whether the apparatus will enter an environment with at least one poor radio conditions;
determine to enter the DTX mode in an event that the apparatus will enter the environment with the at least one poor radio condition; and
transmit, via the transceiver, the DTX information to the network node in response to determining to enter the DTX mode.

14. The apparatus of claim 13, wherein the processor is further configured to:
transmit, via the transceiver, a scheduling request to the network node to acquire a resource for a service, in response to leaving the DTX mode.

15. The apparatus of claim 13, wherein the poor radio condition comprises that a reception is bad in the environment or a signal is weak in the environment.

16. The apparatus of claim 9, wherein the processor is further configured to:
transmit, via the transceiver, the DTX information to the network node through medium access control (MAC) layer signaling or physical layer signaling.

17. A discontinuous transmission (DTX) information transmission method, comprising:
receiving, by a transceiver of a network node, DTX information from a user equipment (UE), wherein the DTX information indicates that the UE will enter a DTX mode; and
determine, by a processor of the network node, a resource allocation based on the DTX information.

18. The DTX information transmission method of claim 17, wherein the UE supports a dual Subscriber Identity Module (SIM) function, and the method further comprises:
receiving, by the transceiver, the DTX information corresponding to a first SIM of the UE from the UE to know that the first SIM will enter the DTX mode; and
stopping, by the processor, providing resource for a first service on the first SIM.

19. The DTX information transmission method of claim 18, further comprising:
allocating, by the processor, a resource for a second service on a second SIM of the UE;
receiving, by the transceiver, the DTX information corresponding to the second SIM from the UE to know that the second SIM will enter the DTX mode;
receiving, by the transceiver, a scheduling request from the UE for the first service; and
allocating, by the processor, the resource for the first service on the first SIM again.

20. The DTX information transmission method of claim 17, further comprising:
receiving, by the transceiver, the DTX information in an event that the UE will enter an environment with at least one poor radio condition.
